(19) United States
(12) Patent Application Publication
(10) Pub. No.: US 2012/0043271 A1
(43) Pub. Date: Feb. 23, 2012

(54) FILTER DEVICE COMPRISING HETEROGENEOUSLY DISTRIBUTED HOLLOW FIBERS AND METHOD FOR THE PRODUCTION THEREOF

(76) Inventor: Matthias Maurer, Oberthal (DE)

(21) Appl. No.: 13/264,500

(22) PCT Filed: Apr. 13, 2010
(86) PCT No.: PCT/EP10/02275

§ 371 Date: Oct. 14, 2011

(30) Foreign Application Priority Data
Apr. 14, 2009 (DE) 10 2009 017 413.3

(51) Int. Cl. B01D 63/02; B28B 17/02; B29C 70/16; B29C 45/14

(52) U.S. Cl. 210/321.9; 264/265; 425/209; 264/482

(57) ABSTRACT

The present invention relates to a filter apparatus having a cylindrical housing and a plurality of hollow fibers, with the hollow fibers being combined to form a bundle in the housing and being embedded and held in each case at the end sides in a molding compound. The invention furthermore relates to a method for the manufacture of a filter apparatus, to a rotation apparatus and its use for the manufacture of a filter apparatus as well as to a dialysis machine having a filter apparatus.

The present invention relates to a filter apparatus having a cylindrical housing and a plurality of hollow fibers, with the hollow fibers being combined to form a bundle in the housing and being embedded and held in each case at the end sides in a molding compound. The invention furthermore relates to a method for the manufacture of a filter apparatus, to a rotation apparatus and its use for the manufacture of a filter apparatus as well as to a dialysis machine having a filter apparatus.

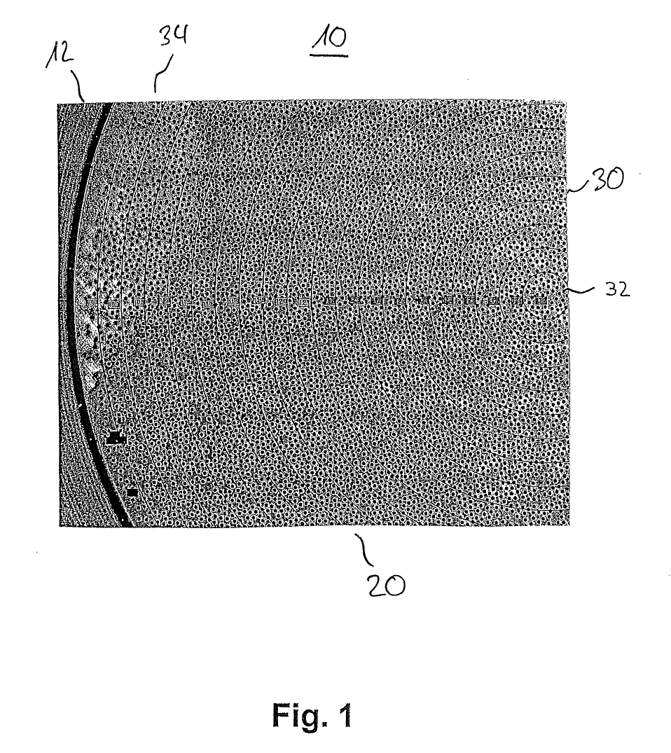

Evaluations of molding sections perpendicular to the longitudinal direction of dialyzers showed that the hollow fibers are distributed in randomized form and not uniformly radially in the housing of the dialyzer (cf. FIG. 1). A reduction in the fiber density could in particular be found in the marginal zones. This low fiber density in the marginal zone is evidently a consequence of the “bundle unraveling” after the molding of the hollow fiber bundle into the housing. In this process, the package density of the hollow fiber membranes in the interior of the bundle is evidently maintained, whereas a relaxation and thus a reduction of the package density occurs in the marginal zone.

Due to the reduced fiber density in the marginal zone, a different flow resistance is present there so that the dialyzate flow is not distributed evenly over the total cross-section perpendicular to the longitudinal direction of the dialyzer.

However, a good flow pattern around all hollow fiber membranes and a homogeneous flow distribution of the dialyzate is desirable for an ideal utilization of the performance data of a dialyzer.

The quality of a dialyzer can be measured with reference to the clearance with respect to predetermined substances. The clearance is defined as the blood volume which is cleared of a specific dissolved substance, e.g. urea, per time unit. The clearance of a dialyzer is in this respect dependent on the flow rates of the liquid flows in the extracorporeal blood circuit, on the membrane surface, on the concentration of the dissolved substance in the blood, on the degree of the convective and diffuse transport via the semipermeable membranes, on the porosity and the pore size of the membrane and on further factors.

A good flow pattern of dialyzate around the blood-guiding hollow fiber membranes is decisive for a clearance improvement which is caused by the transmembrane pressure. A good onflow onto the fibers is, however, not possible homogeneously in the tightly packed arrangement of a fiber bundle in a dialyzer housing.

The fiber density of a fiber bundle in a housing is location-dependent and results in different filtration performance of the fibers in dependence on the location. An onflow with dialyzate cannot take place ideally in tightly packed zones of the fiber bundle. It is possible that too few fibers are available for good filtration in zones which are too loosely packed.

Solution approaches for the aforesaid problem of the unevenly distributed hollow fiber membranes of a dialyzer are already known from the prior art.

U.S. Pat. No. 5,584,997, for example, describes the problem of hollow fiber membranes arranged unevenly or in randomized form and the uneven dialyzate onflow onto the hollow fiber membranes thereby possibly occurring. For the solution, it is proposed to arrange the hollow fiber membranes to form two mats lying above one another and to roll up these common mats in spiral form to achieve a uniform distribution of the hollow fiber membranes. In addition to the fact that this process is complex, a uniform distribution can only be achieved in approximate form. Because the spacing of the fibers in the mat plane is already fixed on the manufacture of the mat and results in irregularities such as buckling or stretching on the rolling up. Gaps at the respective mat ends can also occur in the rolled-up fiber bundle, for instance at the respective ends of the rolled-up mat.

EP 1 714 692 A1 relates to a dialysis filter in which the hollow fiber membrane bundle is fit into a cylindrical filter housing in twisted and compressed form. Zones with different fiber density hereby arise in the bundles in the longitudinal direction of the dialyzer. In this respect, the hollow fiber bundle should have a lower packing density in the inflow zone of the fluid space surrounding the hollow fibers than in the subsequent central zone of the dialyzer.

JP 2003159325 relates to a dialyzer and to a method for its manufacture. In this respect, the fiber bundle of the dialyzer is rotated between two rollers along its longitudinal axis to prevent a sticking or sticking together of the membranes. In addition, where necessary, a coating film to be applied should be able to be applied uniformly over all the hollow fiber membranes and not only also over the outer hollow fiber membranes.

JP 2006297222 relates to a method for the manufacture of a hollow fiber bundle for a dialyzer as well as to a manufacturing apparatus for a dialyzer. Comparably to JP 2003159325, a hollow fiber bundle is here likewise rotated about its longitudinal axis between three rollers to prevent a sticking or sticking together of the membranes. At the same time, a uniform wetting of all fibers of the bundle with a coating film should be made possible.

It is therefore the object of the present invention to further develop a filter apparatus of the initially named kind in an advantageous manner, in particular such that the onflow of the hollow fiber membranes in a filter apparatus is improved to increase the performance capability of the filter apparatus.

This object is solved in accordance with the invention by a filter apparatus having the features of claim 1. Provision is accordingly made that a filter apparatus is made having a cylindrical housing and a plurality of hollow fibers, with the hollow fibers being combined to form a bundle in the housing and being embedded and held in each case at the end sides in a molding compound. Provision is further made that the arrangement of the hollow fibers is homogenized at least region-wise and that the packing density of the hollow fibers with respect to the radial cross-sectional area of the filter apparatus is concentrically homogeneous or is decreasingly or increasingly concentrically homogeneous in a radial direction.

A concentrically homogeneous distribution is, for example, present when the radial distribution is rotationally symmetrical or at least approximately. It can hereby advantageously be avoided that points with different fiber density occur in the marginal zones. It is particularly advantageous that no constructional change is necessary to common filter apparatus and no additional components are necessary.

The homogenization or the avoidance of inhomogeneities in the radial distribution of the hollow fibers can now be achieved, for example by a supplementary corresponding homogenization step in the manufacture of the filter apparatus so that the radial alignment of the hollow fibers is homogenized.

The filter apparatus can advantageously be a dialyzer. It was able to be found in trials that the performance data of the dialyzer could be improved by the homogenization. This was tested, for example, with reference to the clearance for sodium ions or vitamin B12.

Provision can be made that the homogenized arrangement of the hollow fibers in the radial direction is an arrangement by rotation and/or by centrifugal force. It is furthermore possible that the arrangement of the hollow fibers is parallel in the longitudinal direction. It is, for example, conceivable in this connection that the radial arrangement of the hollow fiber bundle was effected by a rotation about the longitudinal axis and the centrifugal force which occurs in this process in a tubular or cylindrical vessel and was then fixed e.g. by the molding compound. Due to the centrifugal force, the hollow fibers can advantageously be distributed or arranged uniformly rotationally symmetrically in a cylinder or tube.

It is furthermore conceivable that the hollow fibers are arranged packed more densely concentrically homogeneously outwardly in the radial direction. The advantage thereby results that the inflow of the dialyzate into the bundle interior is improved so that the hollow fibers which are located in the bundle interior as a rule and are e.g. well flowed through by blood have an improved flow pattern around them. The material exchange from blood into the dialyzate is e.g. thereby improved so that the performance data of the dialyzer is improved overall. The dialyzate distribution can hereby be improved overall.

Provision can advantageously be made that the housing with the bundle of hollow fibers introduced therein, but not yet molded, was rotated or centrifuged about the longitudinal axis during manufacture for the homogeneous concentric arrangement of the hollow fibers. The advantage thereby results that the arrangement obtained by the rotation can be adapted to the housing and can be fixed simply.

It is furthermore possible that the housing is a housing for the on-the-fly molding of the hollow fibers.

It is moreover possible that the average package density of the hollow fibers is between 700-1300 fibers/cm², preferably between 800-1200 fibers/cm², particularly preferably between 850-1150 fibers/cm², and/or that a zone of less fibers in comparison with the remaining cross-section is provided at the center of the bundle with a package density of approximately 500 fibers/cm².

The invention furthermore relates to a method for the manufacture of a filter apparatus having the features of claim 7. Provision is accordingly made that in a method for the manufacture of a filter apparatus, a plurality of hollow fibers are combined to form a bundle, are shaped into a housing and are respectively embedded and held in each case at their end sides in a molding compound. Provision is further made in this respect that the housing with the bundle of hollow fibers not yet molded is rotated or centrifuged about the longitudinal direction. The advantage hereby results that the performance data of a filter apparatus can be improved by a simple and less time-intensive supplement to the manufacturing method. In addition, a homogeneous concentric distribution of the hollow fibers in the radial direction can be set simply.

Provision can advantageously be made that the housing is rotated at a rotational speed of up to 20,000 r.p.m., preferably at a rotational speed of 300-15,000 r.p.m., particularly preferably at a rotational speed of 3,000-9,000 r.p.m.

It is furthermore conceivable that rotation or centrifuging takes place for up to 60 seconds, preferably 5-30 seconds, particularly preferably 5-10 seconds or 25-35 seconds.

It is preferred if centrifuging is carried out for approximately 25-35 seconds, preferably 30 seconds, for the arrangement of the hollow fibers with a package density increasing concentrically homogeneously in the radial direction. An advantageous rotational speed can, for example, be 7,500 r.p.m. in this respect.

Provision can furthermore be made that the method provides a processing step in which the end faces of the hollow fibers are at least partly fixed among one another and/or to one another, in particular that this processing step is a laser processing step, and that the rotation or centrifuging preferably takes place after the processing step or laser processing step. It is also possible to apply a foil or a foil-like substance to the end faces of the hollow fibers for the fixation instead of the laser processing step. Alternatively, a sealing by means of a packing stamp or a similar apparatus is also possible.

It was able to be found in trials that the clearance for sodium ions or for vitamin B12, for example, was able to be increased with respect to previously known dialyzers, in particular when the rotation or centrifuging took place after the processing step or the laser processing step.

It is particularly preferred if it is a case of the manufacture of a filter apparatus in accordance with one of the claims 1 to 6.

The present invention furthermore relates to a rotation apparatus for the manufacture of a filter apparatus having the features of claim 13. Provision is accordingly made that a rotation apparatus has a mount for the filter apparatus for the manufacture of a filter apparatus, with the housing of the filter apparatus being able to be rotated or centrifuged about the longitudinal axis with the not yet molded bundle of hollow fibers.

It is possible that the method in accordance with one of the claims 7 to 12 can be carried out by means of the rotation apparatus and/or that it is a filter apparatus in accordance with one of the claims 1 to 6.

The present invention furthermore relates to the use of a rotation apparatus having the features of claim 15. Provision is accordingly made that a rotation apparatus in accordance with one of the claim 13 or 14 is used for the manufacture of a filter apparatus in accordance with one of the claims 1 to 6 and/or in a method in accordance with one of the claims 7 to 12.

The present invention moreover relates to a dialysis machine having the features of claim 16. Provision is accordingly made that a dialysis machine has a filter apparatus in accordance with one of the claims 1 to 6 and/or a filter apparatus manufactured in accordance with one of the claims 7 to 12. It has proved to be particularly advantageous that an improved dialysis treatment can be carried out using such a dialysis unit and that the performance data of the dialyzer, in particular the achievable clearance, are improved.

Further details and advantages will now be explained in more detail with reference to an embodiment shown in the drawing. There are shown:

FIG. 1: an image of a section through the mold zone of a known filter apparatus;

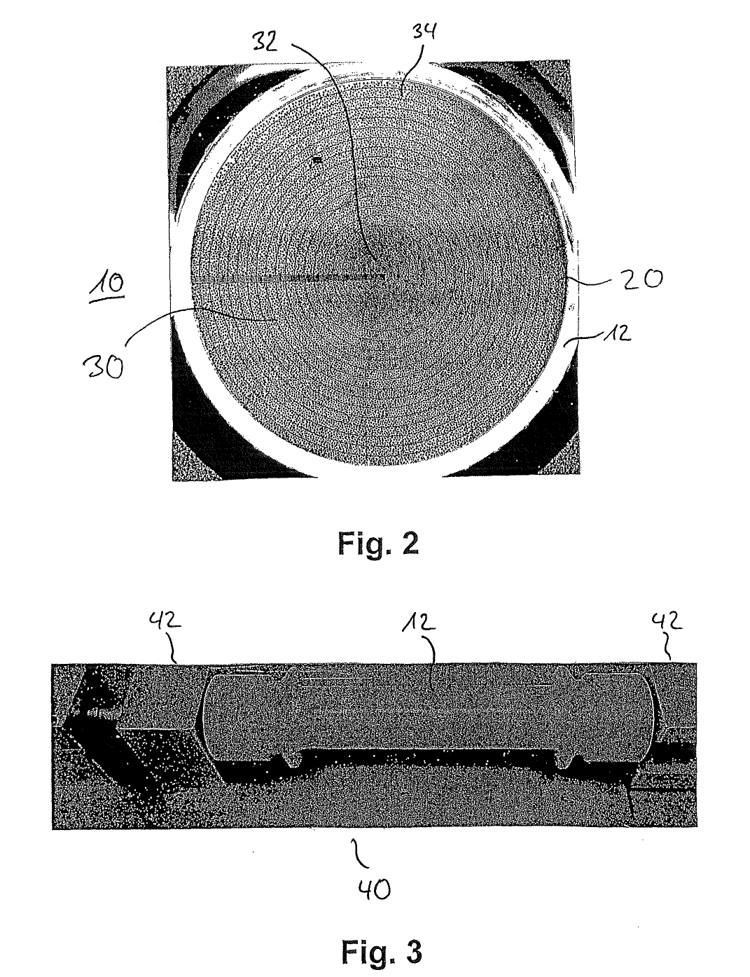

FIG. 2: an image of a section through the mold zone of a filter apparatus in accordance with the invention; and

FIG. 3: a perspective view of a rotation apparatus for the manufacture of a filter apparatus.

FIG. 1 shows a sectional image through the mold zone 20 of a known filter apparatus 10 or of a known dialyzer 10. It can clearly be recognized that the package density of the hollow fibers 30 is reduced in the marginal zones 34, that is, in the zones adjacent to the housing wall. The hollow fibers 30 are in this respect made as semipermeable hollow fiber membranes 30. In this respect the fiber density in the outermost marginal zone 34 amounts to approximately 600 fibers/cm², then increases in the direction of the center 32 to approximately 1000 fibers/cm² and achieves a fiber density of approximately 1200 fibers/cm² in the zone of approximately ¼ of the radius around the center 32.

The observed effect can be explained by the effect of the “bundle unraveling”. On the introduction of the bundle into the cylindrical or tubular housing 12 of the dialyzer 10, the bundle of hollow fiber membranes 30 primarily relaxes in the outer marginal zones 34, whereas the package density in the interior or around the center 32 remains high.

FIG. 2 shows a sectional image through the mold zone 20 of a filter apparatus 10 or of a dialyzer 10 respectively in accordance with the invention. In this respect, on the manufacture of the dialyzer 10, the hollow fiber membrane bundle 30 already shaped into the housing 12, but not molded, was centrifuged before the molding of the ends of the hollow fiber membrane bundle 30. There are no further differences, for instance due to further components in comparison with the dialyzer shown in FIG. 1.

The manufacturing step of the centrifuging can generally take place as follows:

For this purpose the shaped in hollow fiber membrane bundle 30 is shaped into a housing 12 for the so-called on-the-fly molding and is removed from the process chain before or after the lasering. The housing 12 with the shaped in, unmolded hollow fiber bundle 30 is introduced into a rotation apparatus 40 (see FIG. 3) and is rotated about the longitudinal axis of the housing 12 at speeds e.g. between 4,000-7,500 r.p.m. for 5-30 seconds. The shaped in bundles 30 are then immediately subsequently introduced into the normal production process again, are lasered and molded. The sterilization of the filters takes place promptly on adjacent sterilization apparatus or sterilization stations in the same carousel-type machine.

In FIG. 2, the sectional image shows the arrangement of the hollow fiber membranes 30 in the molding zone 20 after a centrifuging at 7,500 r.p.m. for 30 seconds. It can clearly be recognized that the center 32 is much lower in fibers and the package density increases homogeneously concentrically in the radial direction outwardly toward the marginal zone 34. The fiber distribution which results by the centrifuging can be fixed effectively, as the section image through the molding compound 20 shows in FIG. 2.

A fiber density of up to 500 fibers/cm² is thus adopted at the center 32, while a package density of approximately 1,100 fibers/cm² is adopted outwardly from approximately ⅓ of the radius. The fiber distribution shown in FIG. 2 is in particular advantageous because the inflow of the dialyzate into the bundle interior is hereby promoted and the dialysis distribution becomes more uniform.

FIG. 3 shows in a perspective representation a rotation apparatus 40 for the manufacture of a filter apparatus 10 with which the housing 12 with the shaped in and still not yet molded hollow fiber bundle 30 is centrifuged. For this purpose, the housing 12 is clamped in each case at the end sides in two mounts 42 of the rotation apparatus 40 and then centrifuged.

The rotation apparatus 40 is able to rotate the housing 12, in which, for example, a fiber bundle with approximately 14,500 to 16,500 hollow fiber membranes is shaped, in a general range at a rotational speed of 0-20,000 r.p.m. or 0-333 r.p.m. The angular acceleration in this respect is in a range between 1-300/s² and after a start-up time of one second, the rotational speed should be between 60-18,000 r.p.m.

In a favorable range, the rotational apparatus should rotate the housing at a rotational speed of 300-15,000 r.p.m. or 5-250 r.p.s. The angular acceleration in this respect is in a range between 10-150/s² and after a start-up time of one second, the rotational speed should be between 600-9,000 r.p.m.

In a range identified as particularly favorable by trials, the rotational apparatus should rotate the housing at a rotational speed of 3,000-9,000 r.p.m. or 50-150 r.p.s. The angular acceleration in this respect is in a range between 20-80/s² and after a start-up time of one second, the rotational speed should be between 1,200-4,800 r.p.m.

With a smaller housing 12, provision can generally be made to select higher parameters. Alternatively to the angular acceleration, the torque can also be used as the parameter since, with a known moment of inertia of the fibers and of the housing, the angular acceleration is proportional to the torque.

Provision can generally be made that the rotation or centrifuging parameters are stored in a control and/or regulation unit of the rotation device 40 so that the rotation step or centrifuging step can run in an automated process.

1. A filter apparatus (10) having a cylindrical housing (12) and a plurality of hollow fibers (30), wherein the hollow fibers (30) are combined to form a bundle in the housing (12) and are imbedded and held in each case at the end sides in a molding compound (20),
characterized in that
the arrangement of the hollow fibers (30) is homogenized at least region-wise; and in that the packing density of the hollow fibers (30) with respect to the radial cross-sectional area of the filter apparatus (10) is concentrically homogeneous or is decreasingly or increasingly concentrically homogeneous in a radial direction.

2. A filter apparatus (10) in accordance with claim 1, characterized in that the homogenized arrangement of the hollow fibers (30) in the radial direction is an arrangement by rotation and/or by centrifugal force; and/or in that the arrangement of the hollow fibers (30) is parallel in the longitudinal direction.

3. A filter apparatus (10) vehicle in accordance with claim 1, characterized in that the hollow fibers (30) are arranged packaged outwardly concentrically homogeneously more densely in the radial direction.

4. A filter apparatus (10) in accordance with claim 1, characterized in that the housing (12) with the bundle of hollow fibers (30) introduced therein, but not yet molded, was rotated or centrifuged about the longitudinal axis during manufacture for the homogeneous concentric arrangement of the hollow fibers (30).

5. A filter apparatus (10) in accordance with claim 1, characterized in that the housing (12) is a housing (12) for the on-the-fly molding of the hollow fibers (30).

6. A filter apparatus (10) in accordance with claim 1, characterized in that the average package density of the hollow fibers (30) is between 700-1,300 fibers/cm², preferably between 800-1,200 fibers/cm², particularly preferably between 850-1,150 fibers/cm²; and/or in that a zone of less fibers in comparison with the remaining cross section is provided at the center of the bundle with a package density of approximately 500 fibers/cm².

7. A method for the manufacture of a filter apparatus (10), wherein a plurality of hollow fibers (30) are combined to form a bundle, are shaped into a housing (12) and are embedded and held in each case at their end sides in a molding compound (20),
characterized in that
the housing (12) with the not yet molded bundle of hollow fibers (30) is rotated or centrifuged about the longitudinal direction.

8. A method for the manufacture of a filter apparatus (10) in accordance with claim 7, characterized in that the housing (12) is rotated at a rotational speed of up to 20,000 r.p.m., preferably at a rotational speed of 300-15,000 r.p.m., particularly preferably at a rotational speed of 3,000-9,000 r.p.m.

9. A method for the manufacture of a filter apparatus (10) in accordance with claim 7, characterized in that rotation or centrifuging takes place for up to 60 seconds, preferably 5-30 seconds, particularly preferably 5-10 seconds or 25-35 seconds.

10. A method for the manufacture of a filter apparatus (10) in accordance with claim 7, characterized in that centrifuging is carried out for approximately 23-35 seconds, preferably 30 seconds, for the arrangement of the hollow fibers (30) with a package density increasing concentrically homogeneously in the radial direction.

11. A method for the manufacture of a filter apparatus (10) in accordance with claim 7, characterized in that the method provides a processing step in which the end faces of the hollow fibers (30) are at least partly fixed among one another and/or to one another; in particular in that this processing step is a laser processing step; and in that the rotation or centrifuging preferably takes place after the processing step or laser processing step.

12. A method for the manufacture of a filter apparatus (10) wherein a plurality of hollow fibers (30) are combined to form a bundle, are shaped into a housing (12) and are embedded and held in each case at their end sides in a molding compound (20), and wherein the housing (12) with the not yet molded bundle of hollow fibers (30) is rotated or centrifuged about the longitudinal direction, characterized in that it is the case of the manufacture of a filter apparatus (10) in accordance with claim 1.

13. A rotation apparatus (40) for the manufacture of a filter apparatus (10) having a mount (42) for a filter apparatus (10),
characterized in that
the housing (12) of the filter apparatus 10) can be rotated or centrifuged about the longitudinal axis with the not yet molded bundle of hollow fibers (30).

14. A rotation apparatus (40) for the manufacture of a filter apparatus (10) having a mount (42) for a filter apparatus (10), wherein a housing (12) of the filter apparatus (10) can be rotated or centrifuged about the longitudinal axis with a not yet molded bundle of hollow fibers (30), characterized in that the method in accordance with claim 7 can be carried out by means of the rotation apparatus (40); and/or in that it is a filter apparatus (10) having a cylindrical housing (12) and a plurality of hollow fibers (30), wherein the hollow fibers (30) are combined to form a bundle in the housing (12) and are imbedded and held in each case at the end sides in a molding compound (20), and wherein the arrangement of the hollow fibers (30) is homogenized at least region-wise; and in that the packing density of the hollow fibers (30) with respect to the radial cross-sectional area of the filter apparatus (10) is concentrically homogeneous or is decreasingly or increasingly concentrically homogeneous in a radial direction.

15. Use of a rotation apparatus (40) for the manufacture of a filter apparatus (10), said filter apparatus (10) having a mount (42), a cylindrical housing (12) and a plurality of hollow fibers (30), wherein the hollow fibers (30) are combined to form a bundle in the housing (12) and are imbedded and held in each case at the end sides in a molding compound (20), wherein the housing (12) of the filter apparatus (10) can be rotated or centrifuged about the longitudinal axis with a not yet molded bundle of hollow fibers (30), characterized in that the arrangement of the hollow fibers (30) is homogenized at least region-wise; and in that the packing density of the hollow fibers (30) with respect to the radial cross-sectional area of the filter apparatus (10) is concentrically homogeneous or is decreasingly or increasingly concentrically homogeneous in a radial direction, and/or in a method in accordance with claim 7.

16. A dialysis machine having a filter apparatus (10), said filter apparatus (10) having a cylindrical housing (12) and a plurality of hollow fibers (30), wherein the hollow fibers (30) are combined to form a bundle in the housing (12) and are imbedded and held in each case at the end sides in a molding compound (20), characterized in that the arrangement of the hollow fibers (30) is homogenized at least region-wise; and
in that the packing density of the hollow fibers (30) with respect to the radial cross-sectional area of the filter apparatus (10) is concentrically homogeneous or is decreasingly or increasingly concentrically homogeneous in a radial direction, and/or having a filter apparatus (10) manufactured using a method in accordance with claim 7.
